(19) United States
(12) Patent Application Publication
(10) Pub. No.: US 2026/0106052 A1
(43) Pub. Date: Apr. 16, 2026

(54) HIGH-DENSITY SIGNAL DELIVERY

(71) Applicant: International Business Machines Corporation, Armonk, NY (US)

(72) Inventors: Shawn Anthony Hall, Pleasantville, NY (US); Sean Hart, Tarrytown, NY (US)

(21) Appl. No.: 18/917,350

(22) Filed: Oct. 16, 2024

(51) Int. Cl. H01B 7/08; H01B 7/42

(52) U.S. Cl. CPC H01B 7/08; H01B 7/42

(57) ABSTRACT

Systems and techniques that facilitate signal-delivery systems for cryogenic refrigerators are provided. In an embodiment, a structure can comprise a plurality of cables between a lower interconnect assembly and a fanout assembly, wherein the fanout assembly is structured such that each cable of the plurality of cables fans out radially from an inlet to an edge of a vacuum tight casing.

### BACKGROUND

The subject disclosure relates to signal-delivery systems, and more specifically to signal-delivery systems for use in cryogenic refrigerators.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, systems, devices and/or methods that facilitate signal-delivery systems for cryogenic refrigerators are provided.

According to an embodiment, a structure can comprise a plurality of cables between a lower interconnect assembly and a fanout assembly, wherein the fanout assembly is structured such that each cable of the plurality of cables fans out radially from an inlet to an edge of a vacuum tight casing. An advantage of such a structure is that the radial fanout allows for better access to the plurality of cables, thereby allowing for a higher density of cables within a confined space.

In some embodiments, the structure can further comprise one or more thermalization assemblies that thermally anchor the plurality of cables to one or more cryogenic temperature flanges at one or more temperature stages of a cryogenic refrigerator. An advantage of such a structure is that each thermalization assembly provides sinking of heat conducted through the cables from a higher-temperature flange immediately above, lest that heat be conducted to a lower-temperature flange immediately below, whose cooling capacity could be overwhelmed thereby. This advantage is called “thermal anchoring”.

According to another embodiment, a structure can comprise a plurality of cables between a lower interconnect assembly and a fanout assembly; and one or more thermalization assemblies that thermally anchor the plurality of cables to one or more cryogenic temperature flanges at one or more temperature stages of a cryogenic refrigerator. An advantage of such a structure is the aforesaid thermal anchoring.

In some embodiments, the one or more thermalization assemblies can comprise a U-channel bracket and a plurality of thermalization bars within the U-channel bracket, wherein the plurality of thermalization bars are interleaved with the plurality of cables. An advantage of such structure is that the thermalization bars provide better thermal anchoring for high densities of cables, thereby enabling higher densities of cables without overloading the cooling capabilities of the cryogenic refrigerator.

According to another embodiment, a structure can comprise a first plurality of cables located within a vacuum space of a cryogenic refrigerator, with the cables extending between a lower interconnect assembly and a vacuum-tight fanout assembly whose interior volume extends the vacuum space, wherein the vacuum-tight fanout assembly comprises a plurality of feedthrough circuit assemblies. An advantage of such a structure is that the feedthrough circuit assemblies enable communicative coupling between a second plurality of cables outside the vacuum space to the first plurality of cables within the vacuum space.

In some embodiments, feedthrough circuit assemblies of the plurality of feedthrough circuit assemblies further comprises a vacuum seal mounted to an external surface of the vacuum-tight fanout assembly. An advantage of such a system is that the individualized vacuum seals for each circuit card assembly provide more reliably vacuum sealing than other methods utilizing a single seal for multiple cables.

### DESCRIPTION OF THE DRAWINGS

FIG. 1 illustrates a signal-delivery system within a cryogenic refrigerator in accordance with one or more embodiments described herein.

FIGS. 2-4 illustrate a signal-delivery system in accordance with one or more embodiments described herein.

FIG. 5 illustrates a flex-cable array of a signal-delivery system in accordance with one or more embodiments described herein.

FIGS. 6-7 illustrate a flex cable used in a signal-delivery system in accordance with one or more embodiments described herein.

FIG. 8 illustrates a magnified view of a flex-cable array in accordance with one or more embodiments described herein.

FIG. 9 illustrates an alternative magnified view of a flex-cable array in accordance with one or more embodiments described herein.

FIG. 10 illustrates an exploded view of a thermalization assembly in accordance with one or more embodiments described herein.

FIG. 11 illustrates an assembled view of a thermalization assembly in accordance with one or more embodiments described herein.

FIG. 12 illustrates an exploded view of an end cap of a thermalization assembly in accordance with one or more embodiments described herein.

FIG. 13 illustrates an assembled end cap of a thermalization assembly in accordance with one or more embodiments described herein.

FIG. 14 illustrates a cutaway view of an end cap installed in a thermalization assembly in accordance with one or more embodiments described herein.

FIG. 15 illustrates an exploded view of a fanout assembly in accordance with one or more embodiments described herein.

FIG. 16 illustrates an assembled fanout assembly in accordance with one or more embodiments described herein.

FIG. 17 illustrates a harp structure of a fanout assembly in accordance with one or more embodiments described herein.

FIG. 18 illustrates a feedthrough circuit-card assembly in accordance with one or more embodiments described herein.

FIGS. 19 and 20 illustrate a fanout assembly populated with flex cables in accordance with one or more embodiments described herein.

FIGS. 21-33 illustrate a process of assembling a signal-delivery system within a cryogenic refrigerator in accordance with one or more embodiments described herein.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

Quantum computers with superconducting qubits require many electrical signals to be delivered from a room-temperature, atmospheric-pressure environment to a cryogenic-temperature, vacuum-pressure environment inside a cryogenic refrigerator. Facilitating transmission of the electrical signals can entail numerous difficulties. For example, the requisite large number of signals necessitates a large number of transmission cables, which can lead to difficulties related to reliability, ease of setup, and design and manufacturing costs. Furthermore, the heat load generated by the transmission cables can in some cases overload the cooling capabilities of various temperature stages of the cryogenic refrigerator.

In one or more embodiments described herein, systems, devices and/or methods that facilitate modular cryostats that facilitate high-density signal delivery are described that address the above-described problems with signal delivery within cryogenic refrigerators. In one or more embodiments described herein, a structure can comprise a plurality of cables between a lower interconnect assembly and a fanout assembly, wherein the fanout assembly is structured such that each cable of the plurality of cables fans out radially from an inlet to an edge of a vacuum tight casing. Accordingly, the radial fanout allows for induvial access to a greater number of cables, and thus the plurality of cables can comprise a density of cables greater than otherwise possible.

In one or more additional embodiments, a structure can comprise a plurality of cables between a lower interconnect assembly and a fanout assembly; and one or more thermalization assemblies that thermally anchor the plurality of cables to one or more cryogenic temperature flanges at one or more temperature stages of a cryogenic refrigerator. Accordingly, the thermalization assemblies allow for heat being conducted through the plurality of cables to be intercepted at each flange. This prevents the heat load from higher-temperature stages overwhelming the cooling capacity of lower-temperature stages, thereby enabling a greater number of cables.

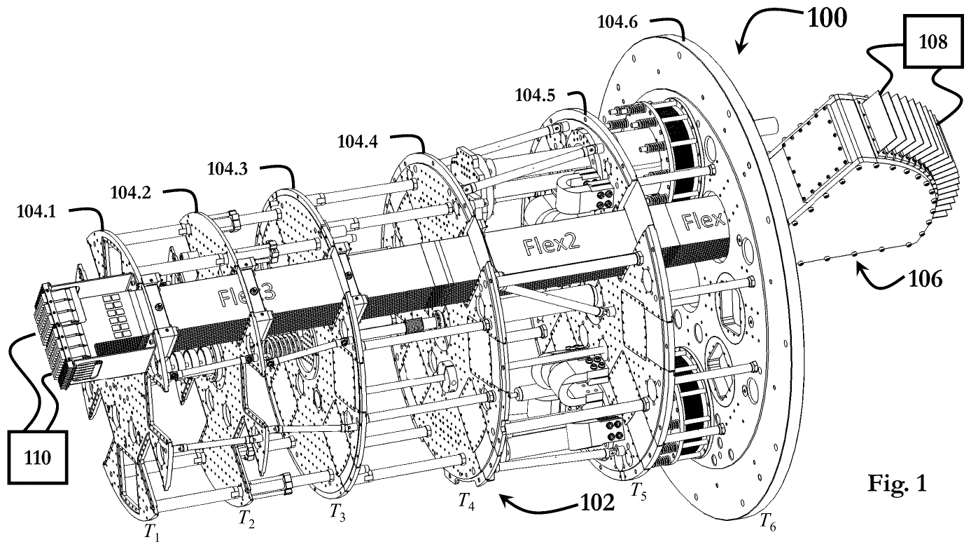

Referring to FIG. 1, a cryogenic cooled signal-delivery system 100 can comprise a cryogenic refrigerator 102 that can comprise cooling means to produce temperatures T₁, T₂, T₃, T₄, T₅, T₆ on a set of refrigerator flanges 104.1 through 104.6, respectively, where T₁<T₂<T₃<T₄<T₅<T₆. T₁ is base temperature (typically 20 mK), and T₆ is room temperature. In various embodiments, refrigerator 102 can further comprise a plurality of thermal shields and an outer vacuum can that are not shown. Furthermore, as shown, at least one signal-delivery system 106 can deliver electrical signals from room-temperature equipment 108 at temperature T₆ to base-temperature equipment through lower interconnect assembly 110 at cryogenic temperature T₁.

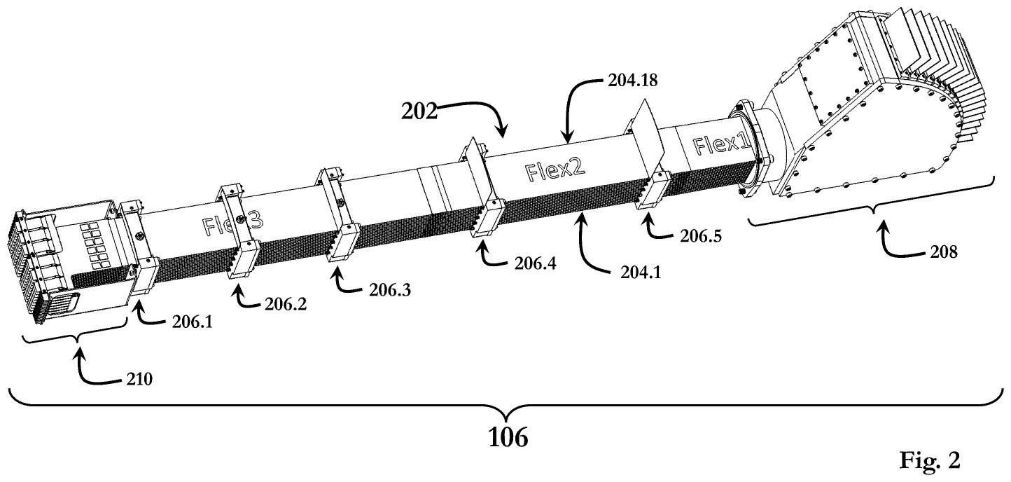

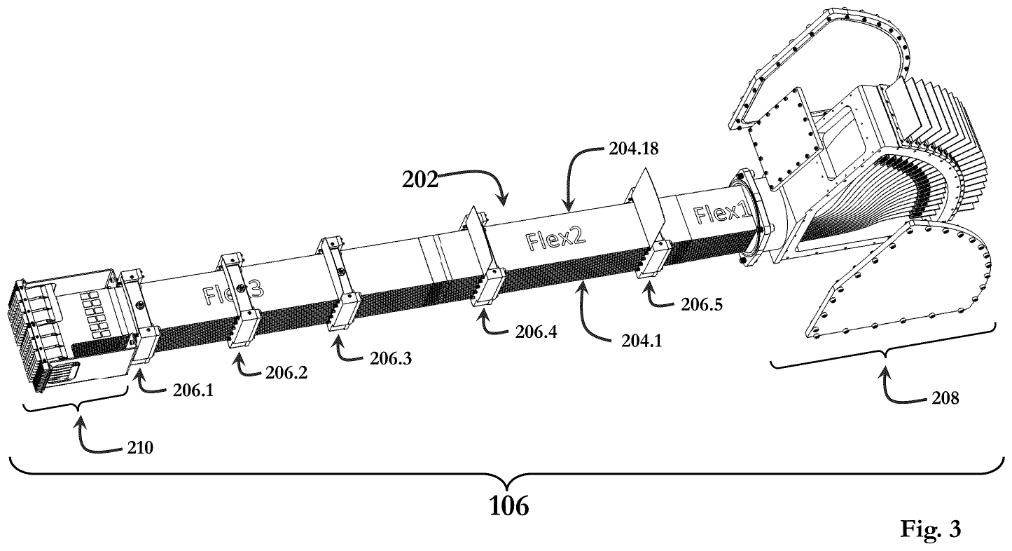

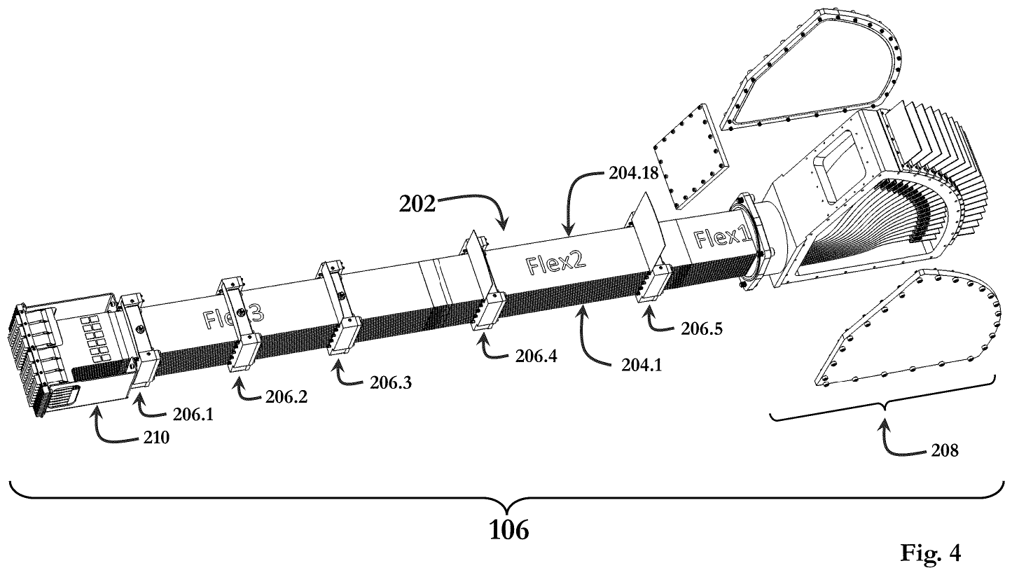

Referring to FIGS. 2, 3 4, and 5, signal deliver system 106 can comprise a cable array 202, which can comprise an integer number N of flex-cable assemblies 204.1 through 204.N, where the figures herein illustrate N=18. As shown, a set of thermalization assemblies, 206.1, 206.2, 206.3, 206.4, and 206.5, are affixed to cryogenic flanges 104.1, 104.2, 104.3, 104.4 and 104.5 respectively. Accordingly, signal-delivery system 106 is thermally anchored to each temperature stage of cryogenic refrigerator 102. Thermal anchoring at temperature Tᵢ provides, at flange 104.i, sinking of heat that is conducted through the cables from flange 104.i+1, lest that heat be conducted to flange 104.i−1, whose cooling capacity could be overwhelmed thereby. While the example presented herein comprises five cryogenic temperature stages, and thus five thermalization assemblies, it should be appreciated that use of any number of temperature stages and a corresponding number of thermalization assemblies is envisioned. As shown, a fan-out assembly 208 is affixed to room-temperature refrigerator flange 104.6 and can enable electrical connection of flex-cable assemblies 204 to room-temperature equipment 108. Furthermore, lower thermalization assembly 210 can enhance heat removal from the base-temperature portion of cable array 202, further preventing excessive heat load base-temperature portion of cryogenic refrigerator 102. FIGS. 3 and 4 illustrate an exploded view of fan-out assembly 208.

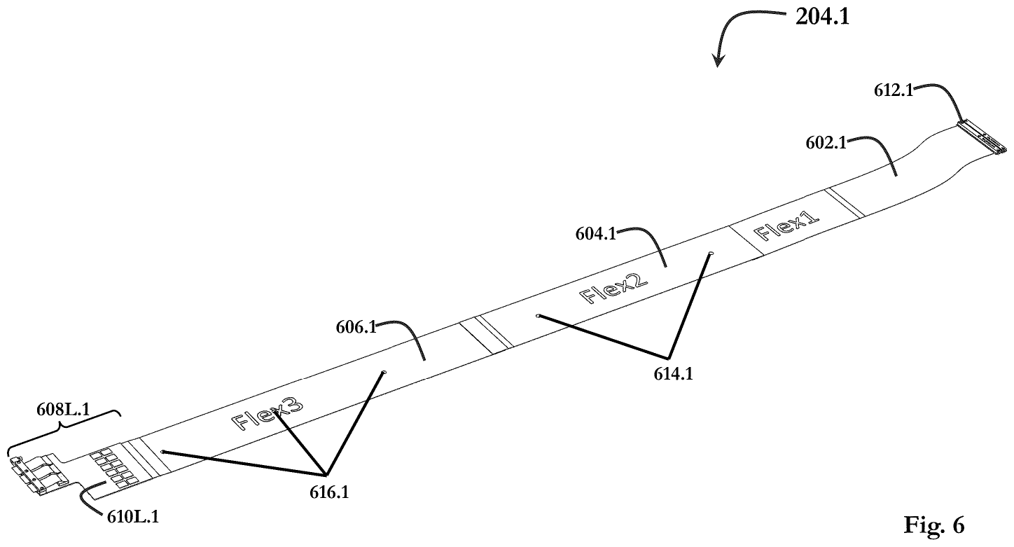

Referring to FIG. 6, cable 204.1 can comprise a first flex-cable segment 602.1, a second flex-cable segment 604.1, a third flex-cable segment 606.1, and a left-handed cable termination assembly 608L.1 that can comprise a left-handed circuit card 610L.1, wherein an upper portion of flex-cable segment 602.1 can be electrically connected to at least one connector 612.1, a lower portion of flex-cable segment 602.1 can be electrically coupled to an upper portion of flex-cable segment 604.1, a lower portion of flex-cable segment 604.1 can be electrically coupled to an upper portion of flex-cable segment 606.1, and a lower portion of flex-cable segment 606.1 can be electrically coupled to an upper portion of left-handed card 610L.1. Electrically coupling the flex-cable segments enables a composite cable having a relatively long length (e.g., approximately 1400 mm) despite manufacturing procedures that limit the length of each segment to approximately 560 mm. Holes 614.1 in flex-cable segment 604.1, as well as holes 616.1 in flex-cable segment 606.1, can be used to align cable 204.1 during an assembly process detailed subsequently. In various embodiments, use of alternative forms of cables containing a plurality of microstrip or stripline channels is envisioned.

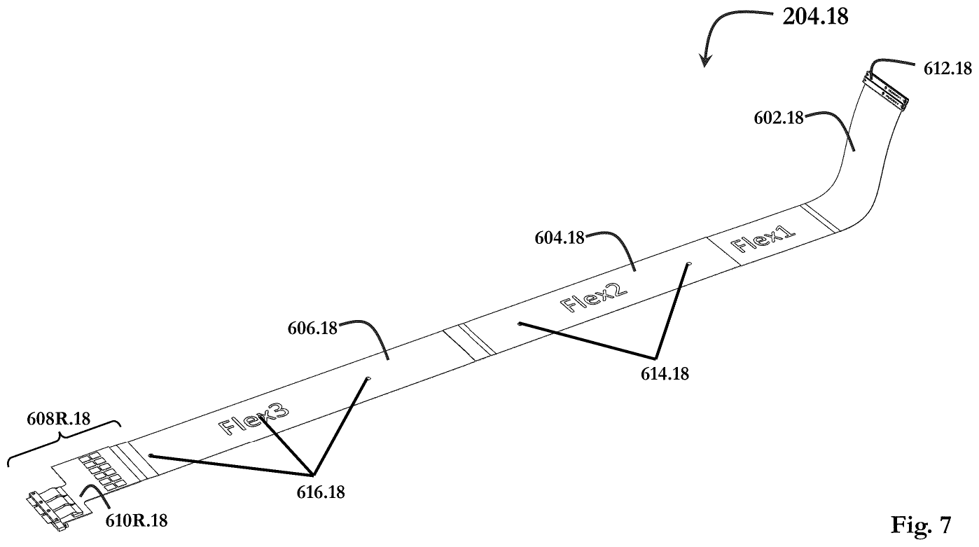

Referring to FIG. 7, cable 204.18 can comprise first flex segment 602.18, second flex segment 604.18, third flex segment 606.18, and a right-handed cable-termination assembly 608R.18 that can comprise a right-handed circuit card 610R.18, wherein the upper portion of flex segment 602.18 can be electrically terminated by at least one connector 612.18, a lower portion of flex segment 602.18 can be electrically coupled to an upper portion of flex segment 604.18, a lower portion of flex segment 604.18 can be electrically coupled to an upper portion of flex segment 606.18, a lower portion of flex segment 606.18 can be electrically coupled to an upper portion of card 610R.18.

Referring to cables 204.1 through 204.18 collectively as 204.i, where i is an integer index ranging from 1 to N, it should be appreciated that, like flex segments 604 and 606, flex segment 602 is identical for all values of i. For different values of i, segment 602 is illustrated with different shapes, but merely because cable 602 is flexible, and thus accommodates the different shapes. Left-handed circuit card 610L, in which the distal portion thereof is offset to the left, is used for odd values of index i (1, 3, 5, . . . ), as illustrated for i=1 by FIG. 6, whereas right-handed circuit card 610R, in which the distal portion thereof is offset to the right, is used for even values of index i (2, 4, 6, . . . ), as illustrated for i=18 by FIG. 7. Holes 614.18 in flex-cable segment 604.18, as well as holes 616.18 in flex-cable segment 606.18, can be used to align cable 204.18 during an assembly process detailed subsequently.

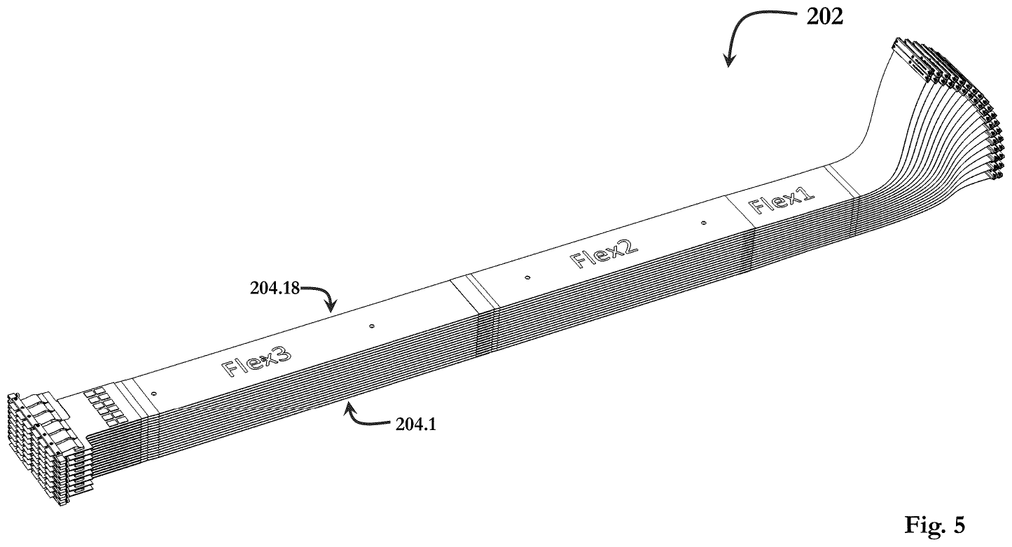

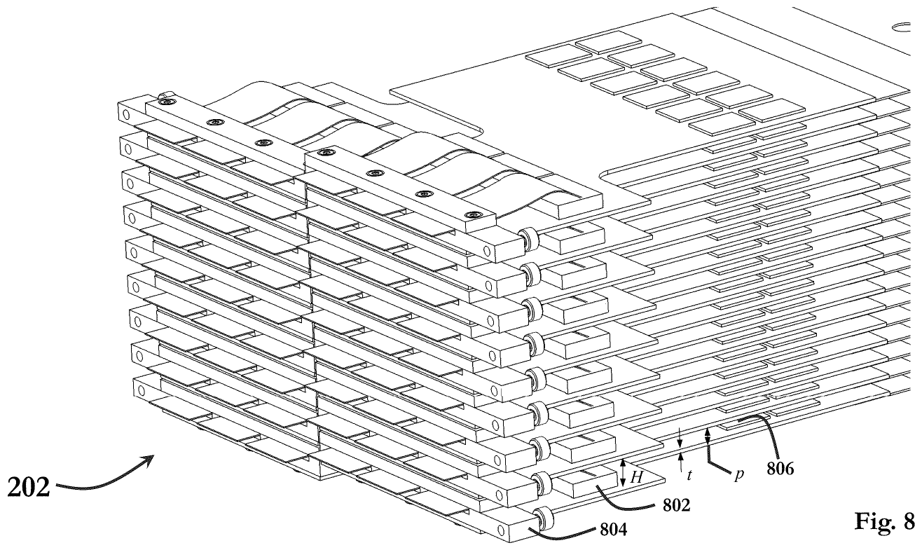

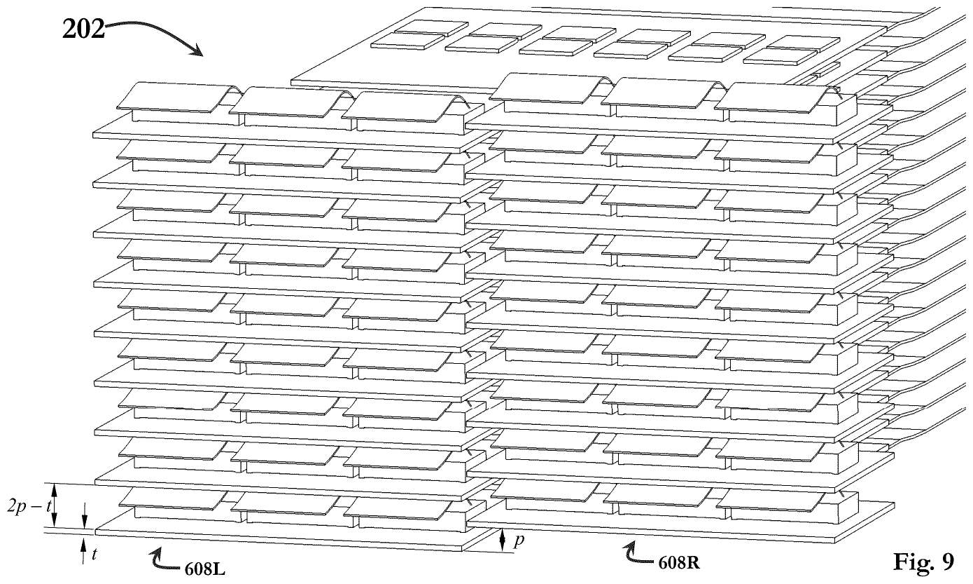

FIG. 8 illustrates a magnified view of the lower-left portion of FIG. 5, and FIG. 9 is a cutaway end view thereof. Referring to FIG. 8 and FIG. 9, each cable-termination assembly 608L and 608R can comprise a plurality of card-to-cable connectors 802, strain-reliefs 804, and signal conditioning devices 806. The purpose of using left-handed cable termination assemblies 608L for odd i (1, 3, 5, . . . ) and right-handed cable-termination assemblies 608R for even i (2, 4, 6, . . . ) is to provide sufficient headroom H for connectors 802 and strain reliefs 804. That is, defining a cable-to-cable pitch p and a card thickness t, if left-right alternation were absent, H=p−t, whereas, because left-right alternation is used, H=2p−t. So, for example, if p=4.5 mm and t=0.5 mm, H=4.0 mm without left-right alternation, whereas H=8.5 mm with left-right alternation. Thus, left-right alternation accommodates connectors and strain reliefs (such as those shown) that would otherwise not fit.

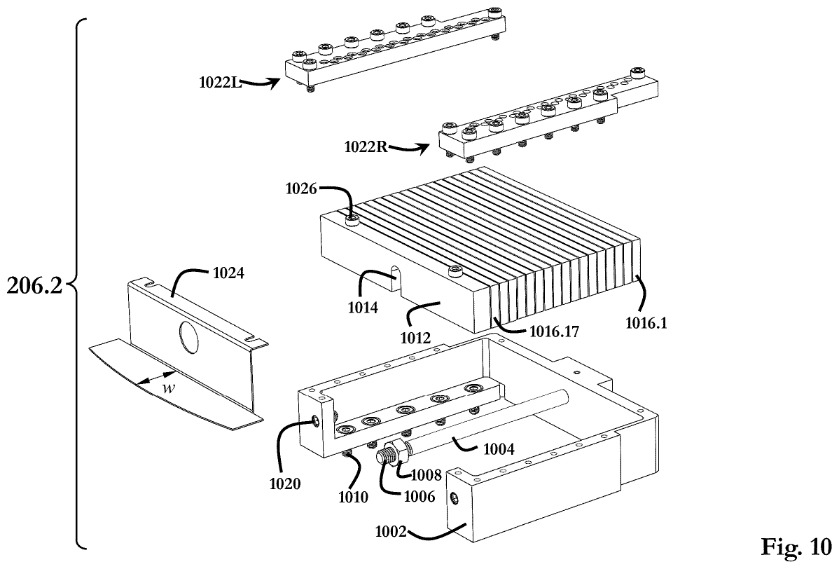

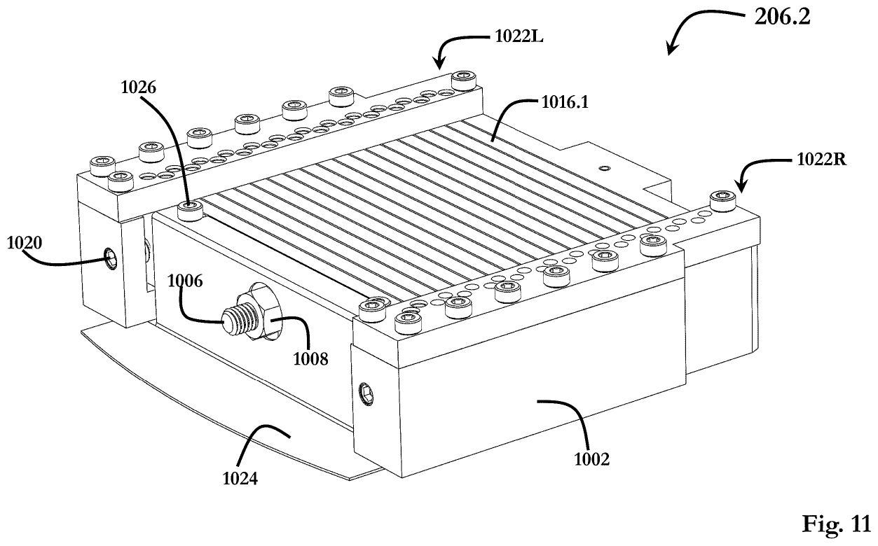

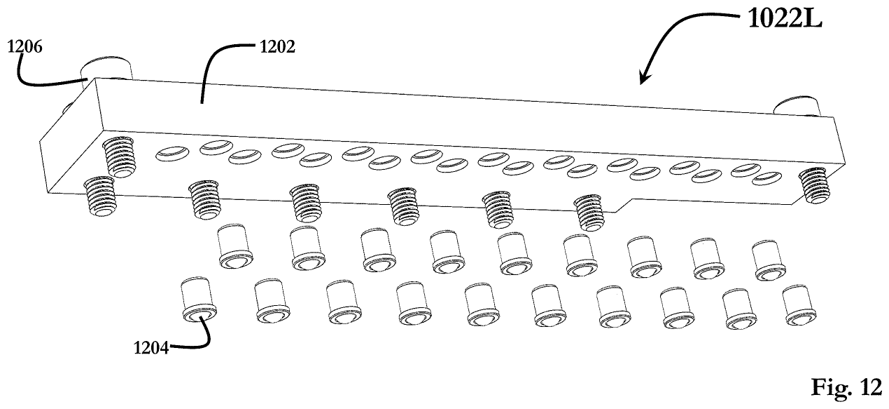

Thermalization assembly 206.2, illustrated exploded and assembled in FIG. 10 and FIG. 11, respectively, can comprise a U-channel 1002; a post 1004 affixed to U-channel 1002 that can comprise a thread 1006 at its distal end, a nut 1008 that engages thread 1006; a plurality of fasteners 1010, counterbored into a left-and-right pair of surfaces 1011, that can affix U-channel 1002 to thermal flange 104.2 (FIG. 1) to ensure good thermal conductance therebetween; a front thermalization bar 1012 that can comprise a notch 1014; an array of flex-cable thermalization bars 1016.1 through 1016.17, referred to collectively as 1016.i, where i=1, . . . , 17, each of which can comprise a notch 1018 (not visible in FIG. 10) similar to notch 1014; a pair of fasteners 1020 threaded into holes in U-channel 1002 that can bear on front thermalization bar 1012; a left thermalization-cap assembly 1022L, further explicated in FIGS. 12, 13, 14; a right thermalization-cap assembly 1022R, further explicated in FIGS. 12, 13, 14; a radiation shield 1024 comprising a bottom flange of width w; and a pair of screws 1026 that can affix radiation shield 1024 to front thermalization bar 1012. Each of the other thermalization assemblies—206.1, 206.3, 206.4, 206.5—can be identical to 206.2, except that width w differs.

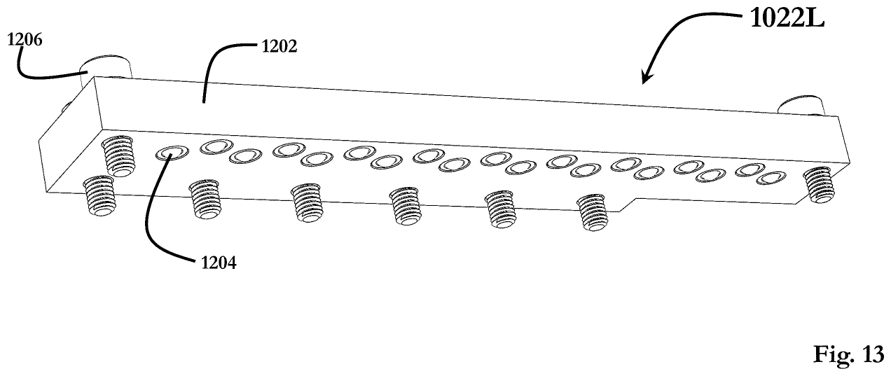

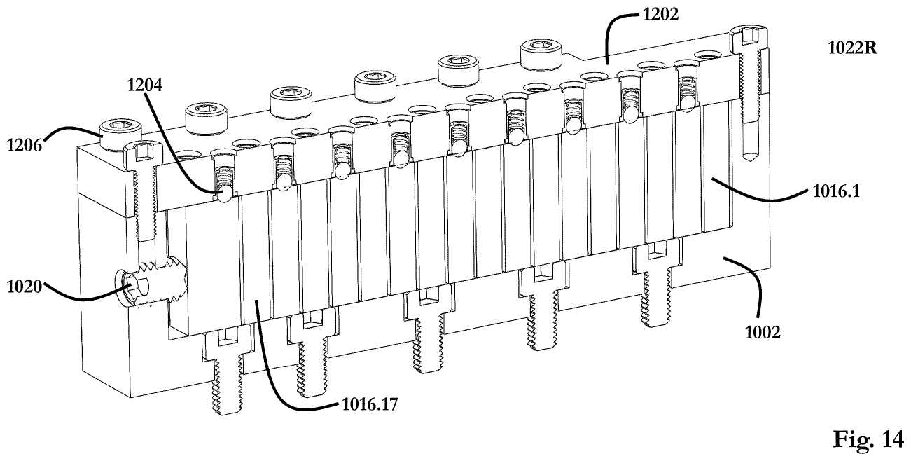

Left thermalization-cap assembly 1022L is illustrated exploded in FIG. 12, assembled in FIG. 13, and installed upon thermalization assembly 206.2 in cutaway FIG. 14. Left thermalization-cap assembly 1022L comprises a thermalization cap 1202; a plurality of thermally conductive compliant elements 1204 such as spring-loaded ball plungers, each of which bears against one of the thermalization bars 1016i or the front thermalization bar 1012; and a plurality of fasteners 1206 for affixing assembly 1022L to U-channel 1002, thereby to compress compliant elements 1204 and achieve good thermal heat conduction both from thermalization bars 1016i and 1012 to thermalization cap 1202, and also from thermalization cap 1202 to U-channel 1002. Right thermalization-cap assembly 1022R is analogous to 1022L.

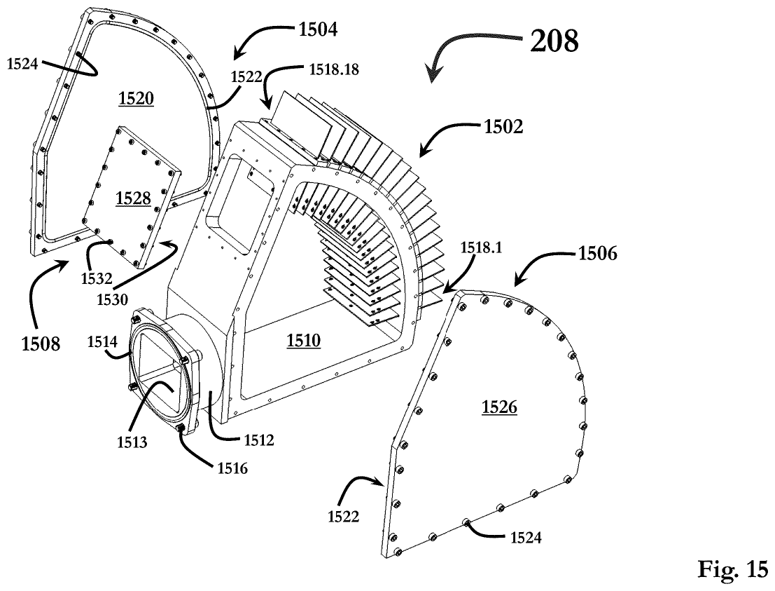

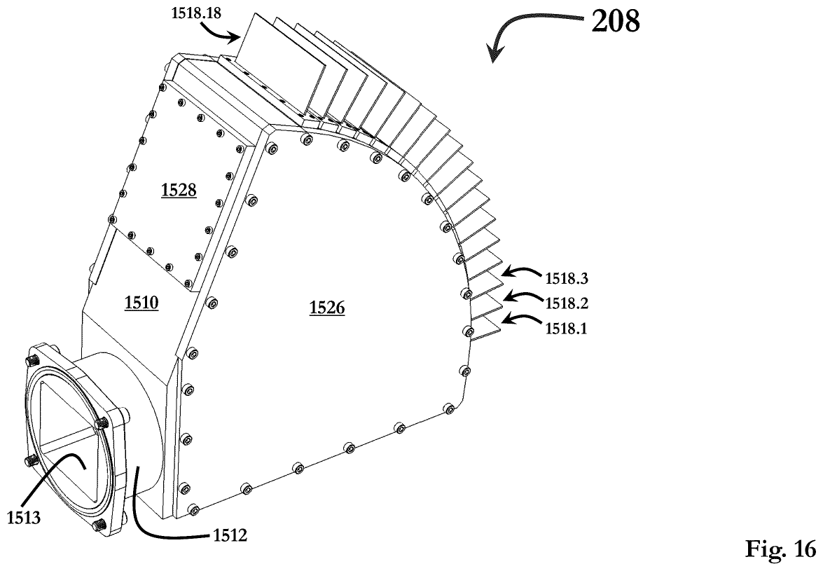

Fan-out assembly 208, shown exploded in FIG. 15 and assembled in FIG. 16, can comprise a harp assembly 1502, a left side-plate assembly 1504, a right side-plate assembly 1506, and a front-plate assembly 1508. Harp assembly 1502 can comprise a harp 1510; a harp base 1512 (comprising aperture 1513) that can be welded to harp 1510; a harp-base O-ring 1514 that can effectuate a vacuum seal between harp base 1512 and room-temperature refrigerator flange 104.6; a plurality of harp-base screws 1516 that can mount harp base 1512 upon room-temperature flange 104.6; and a plurality of feedthrough circuit-card assemblies 1518.1 through 1518.18 (collectively referred to as 1518.i, where i is an index ranging from 1 to N) that can pass through slots in harp 1510, and that can be attached to connectors 612.i on flex cables 204.1 through 204.18, respectively.

Left-side-plate assembly 1504 can comprise a left-side plate 1520, a first instance of harp-side-plate O-ring 1522 that can effectuate a vacuum seal between plate 1520 and harp 1510, and a first plurality of harp-side-plate-attach screws 1524. Right-side-plate assembly 1506 can likewise comprise a right-side plate 1526, a second instance of harp-side-plate O-ring 1522 that can effectuate a vacuum seal between plate 1526 and harp 1510, and a second plurality of harp-side-plate-attach screws 1524. Front-plate assembly 1508 can comprise a front plate 1528, a harp-front-plate O-ring 1530 (not visible in FIG. 15), and a plurality of harp-front-plate-attach screws 1532.

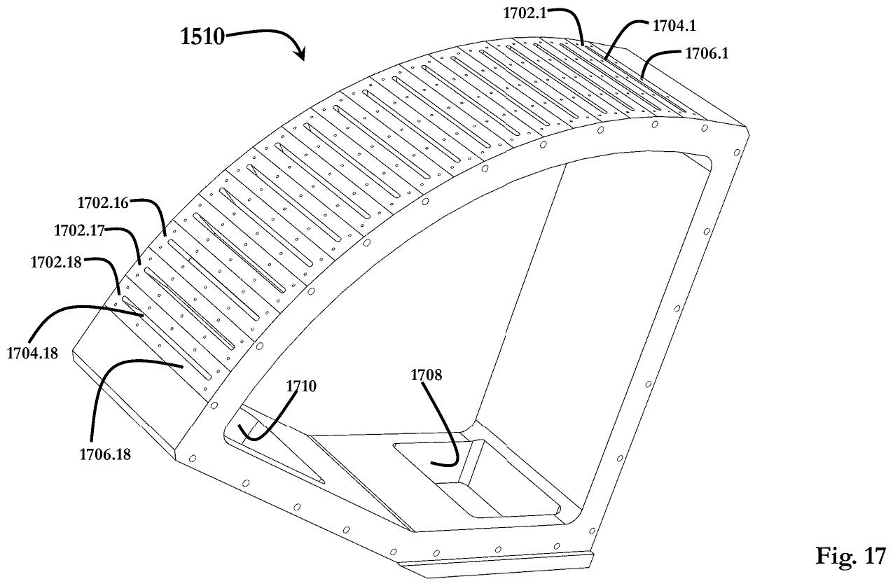

Referring to FIG. 17, harp 1510 can comprise N faceted surfaces 1702.1 through 1702.18, collectively referred to as 1702.i, where i is an index ranging from 1 to N. As illustrated for 1702.18, each faceted surface 1702.i can comprise a slot 1704.i and a plurality of blind tapped holes 1706.i. Harp 1510 can also comprise base aperture 1708 and front aperture 1710. Due to apertures 1513 and 1708, and to O-rings 1514, 1522, and 1530, the interior of fan-out assembly 208 (i.e., the volume inside harp 1510 and harp base 1512) are under vacuum whenever refrigerator 102 is under vacuum. Thus, the fan-out assembly may be considered as extending the vacuum space of refrigerator 102.

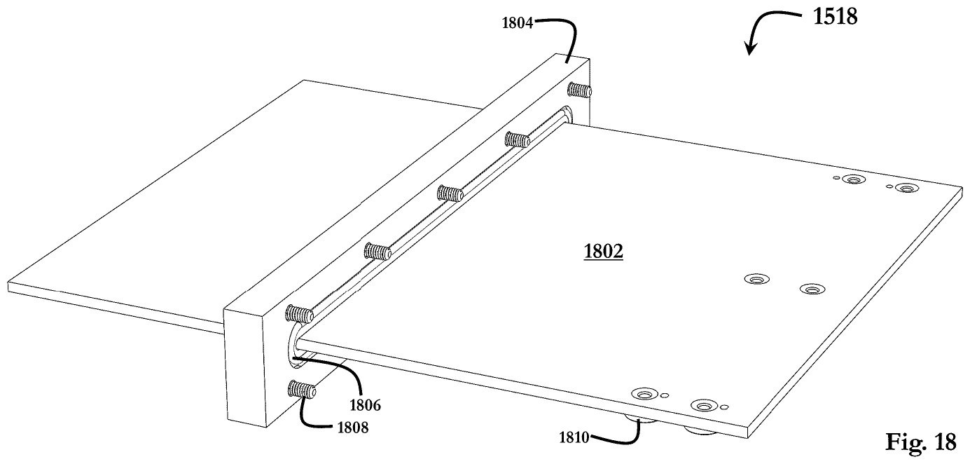

Referring to FIG. 18, each feedthrough circuit-card assembly 1518.i (i=1, . . . , N) an comprise a feedthrough circuit card 1802, a flange 1804 that is joined to circuit-card 1802 in a manner (e.g., soldering) that prevents gaseous transmission therebetween, an O-ring 1806 that effectuates a vacuum seal between flange 1704 and faceted surface 1702.i of harp 1510, a plurality of fasteners 1808 that compress feedthrough O-ring 1806 against faceted surface 1702.i of harp 1510, and a plurality of fasteners 1810 for attachment of connectors 612 to circuit card 1802, upon which are surface features (not shown) that connect electrically to connectors 612. Any of these items can be suffixed to specify a specific circuit-card assembly. For example, 1802.i specifies the circuit card 1802 corresponding to circuit-card assembly 1518.i.

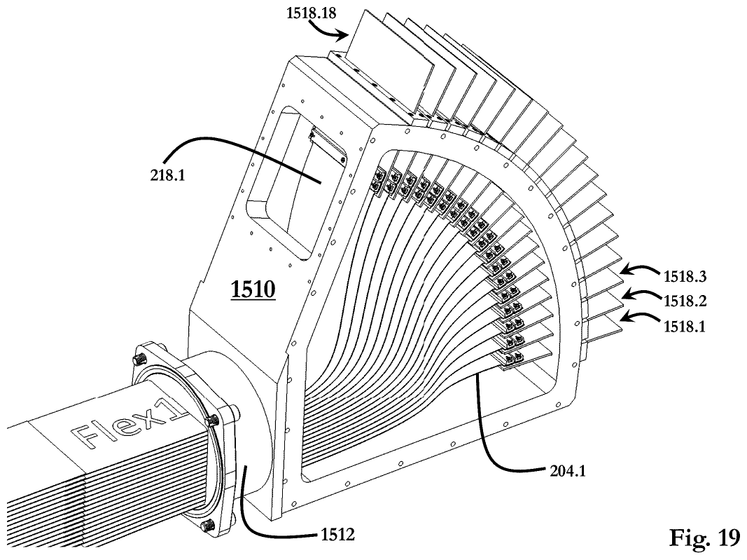

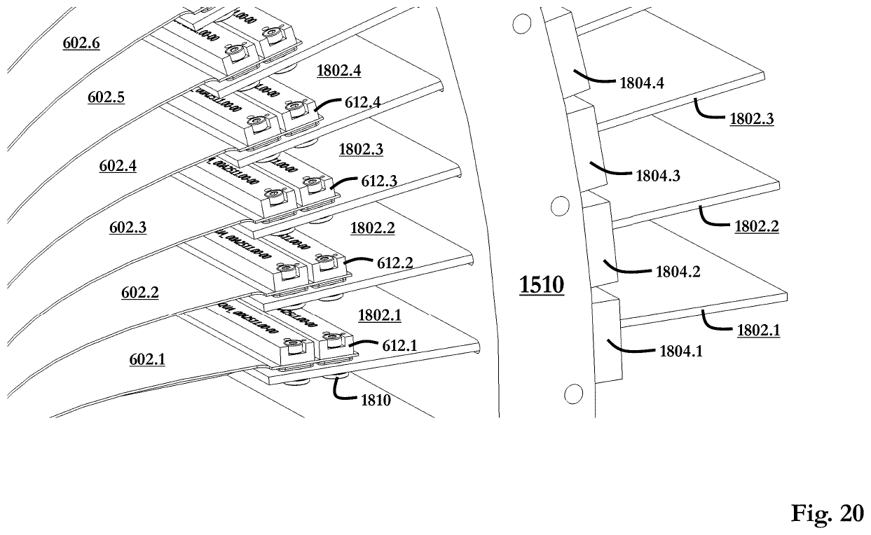

FIG. 19 and FIG. 20 illustrate fan-out assembly 208 populated with flex-cable assemblies 204.1 through 204.18. The shape of harp 1510 is designed so that all flex cables 204.i have the same or substantially similar length, thereby simplifying design and manufacturing thereof. FIG. 20 illustrates a close-up view of the connection between several of the feedthrough circuit cards 1802.i and the corresponding upper segment 602.i of flex-cable assembly 204.i. These connections can be made using board-to-board connectors 612 well known in the art.

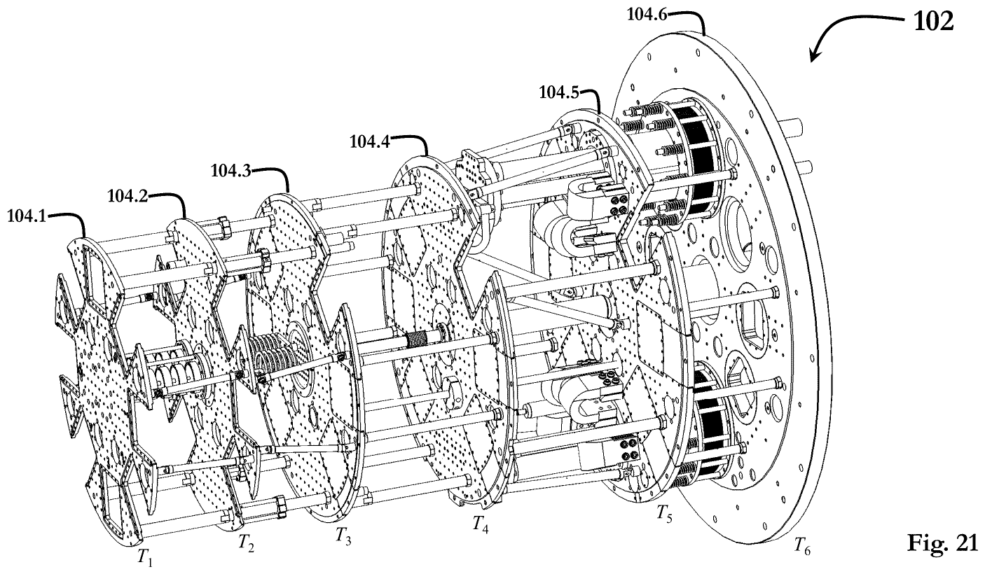

FIG. 21 through FIG. 33 illustrate how signal-delivery system 106 can be assembled upon a standard cryogenic refrigerator 102. For reference, refrigerator 102 is illustrated in FIG. 21 alone, prior to installation of signal-delivery system 106.

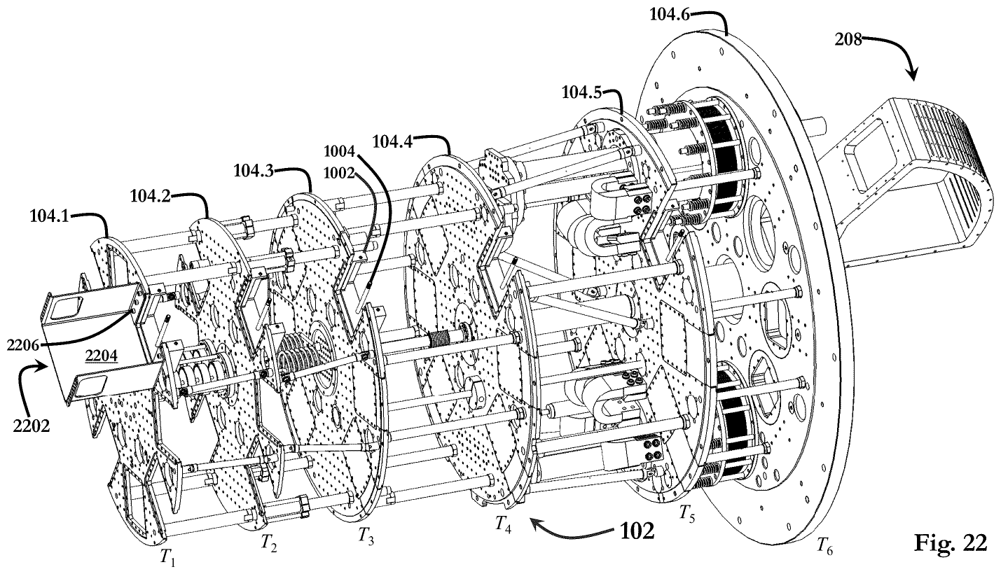

Referring to FIG. 22, assembly of signal-delivery system 106 can begin by attachment of the following equipment to cryogenic refrigerator 102: first, beneath flange 104.1, a base-temperature thermalization assembly 2202 that can comprise a base-temperature bracket 2204 and screws 2206 that affix bracket 2204 to flange 104.1; second, above each of the flanges 104.1, 104.2, 104.3, 104.4 and 104.5, an instance of U-channel 1002 and post 104 affixed thereto; and third, above room-temperature flange 104.6, fan-out assembly 208 with side-plate assemblies 1504, 1506 and front-plate assembly 1508 temporarily removed, and also with circuit-card assemblies 1518 temporarily removed.

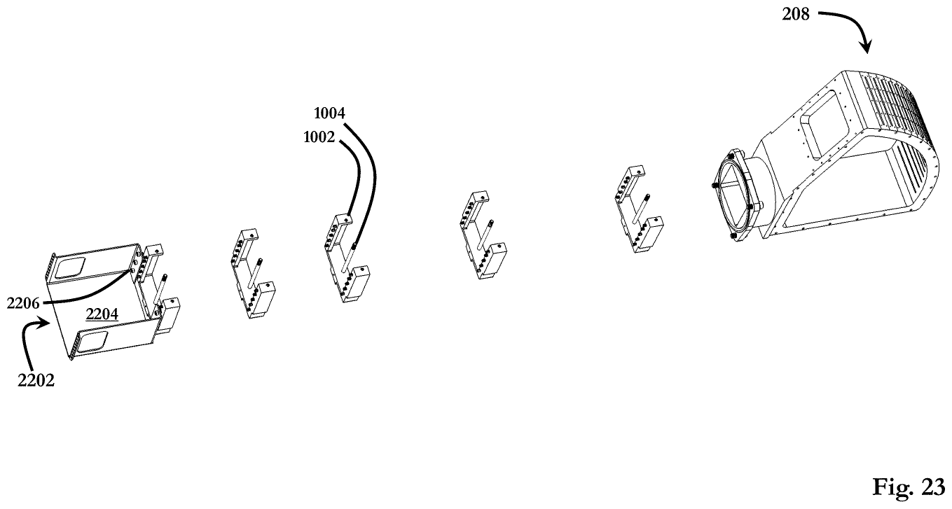

For visual clarity, FIG. 23 duplicates FIG. 22, but with refrigerator 102 hidden, thereby illustrating clearly components of the signal-delivery system 106 only. Likewise, in subsequent figures illustrating the assembly process of signal-delivery system 106 upon refrigerator 102, refrigerator 102 will be hidden.

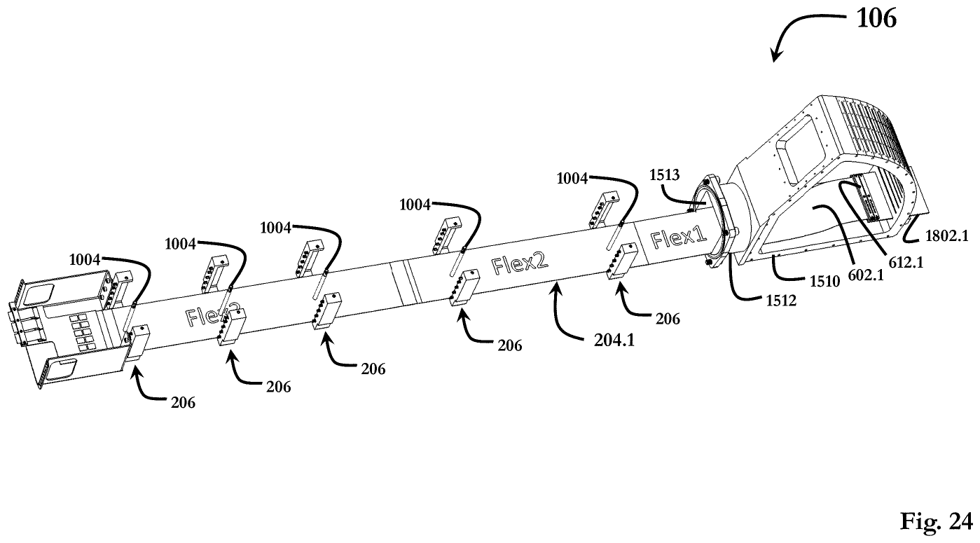

Referring to FIG. 24 as well as to FIG. 17, to begin population of signal-delivery system 106, circuit card 1802.1 can be inserted through slit 1704.1 of harp 1510, and it can be secured with screws 1808.1 that engage blind tapped holes 1706.1 in harp 1510, thereby compressing feedthrough O-ring 1806.1.

Still referring to FIG. 24 and FIG. 17 but also referring to FIG. 6, segment 602.1 of cable 204.1 can then be fed through aperture 1513 of harp base 1512 as well as through base aperture 1708 of harp 1510. At substantially the same time, holes 614.1 and 616.1 in cable 204.1 can be threaded over posts 1004 of the five thermalization assemblies 206, thereby to align cable 204.1 upon system 106. The upper end of segment 602.1 can be connected to circuit card 1802.1 using connectors 612.1.

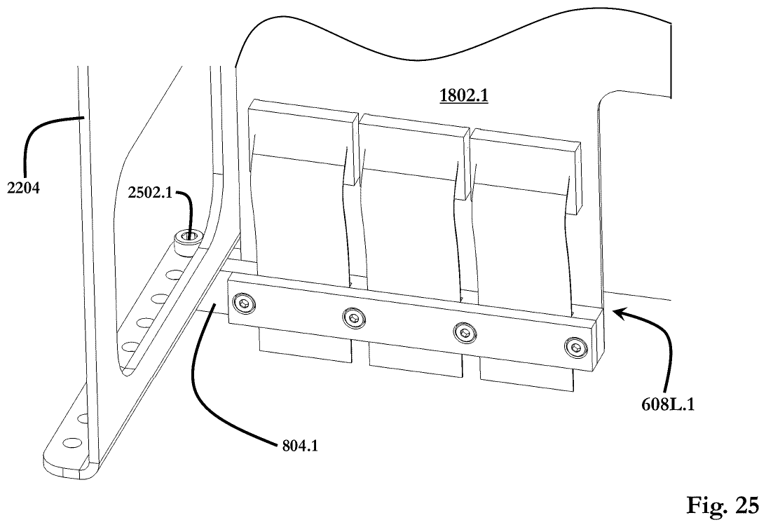

Referring to FIG. 25, the installation of cable 204.1 can be completed by affixing, at the lower end of signal-delivery system 106, strain relief 804.1 to base-temperature bracket 2204 using screw 2502.1, thereby to ensure thermalization of cable-termination assembly 608L.1 to base temperature T₁. This thermalization can occur because, at its upper end (illustrated in FIG. 22), bracket 2204 is affixed to base-temperature flange 104.1 by screws 2206.

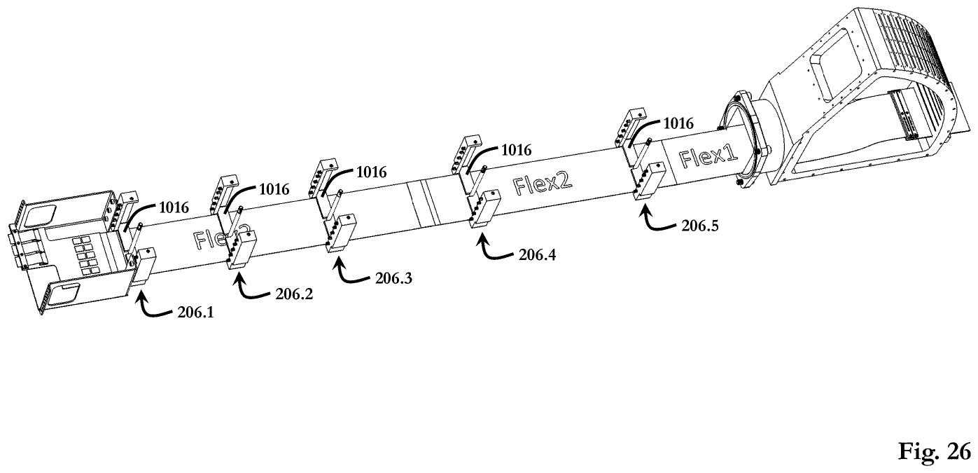

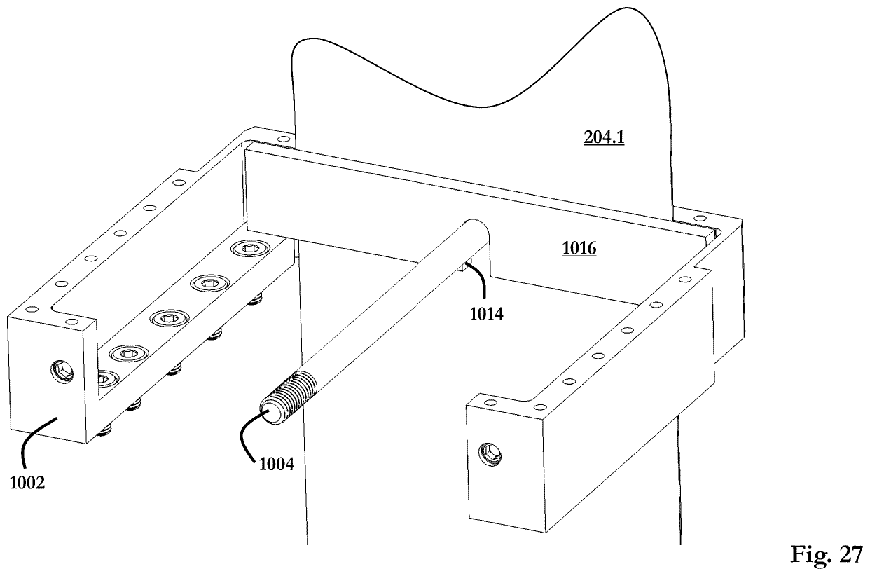

Referring to FIG. 26 and FIG. 27, the next step in populating signal-delivery system 106 is to insert a thermalization bar 1016 at each of the thermalization assemblies 206.1, 206.2, 206.3, 206.4, and 206.5. As illustrated in FIG. 27, each bar 1016 is inserted by dropping notch 1014 of bar 1016 over post 1004.

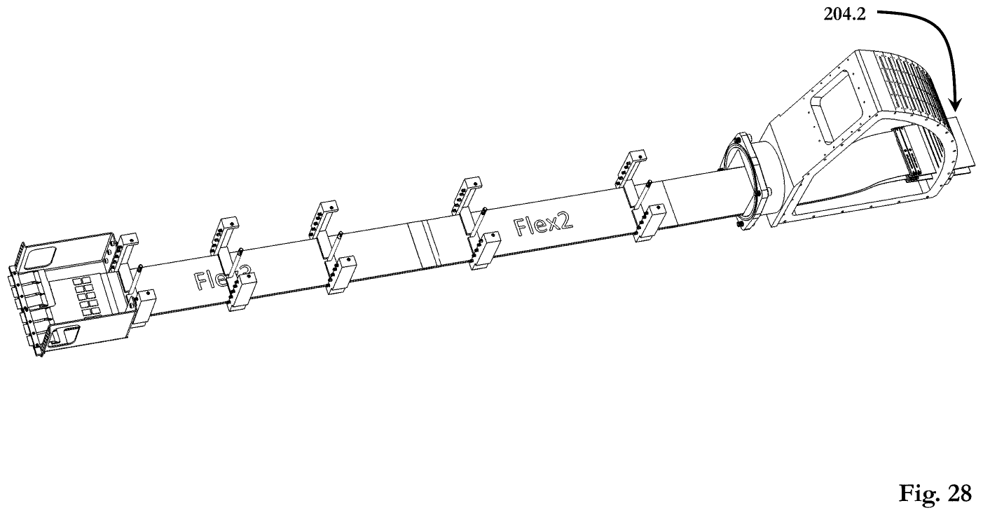

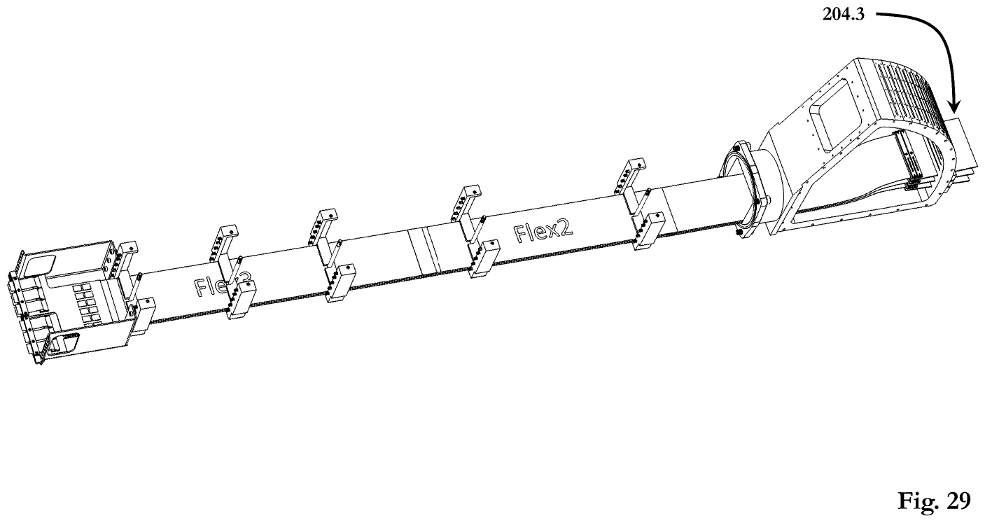

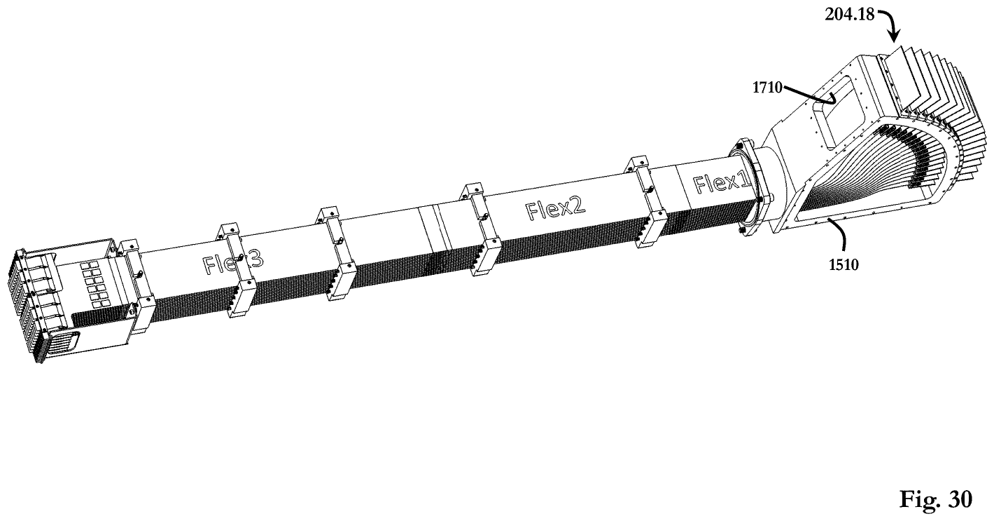

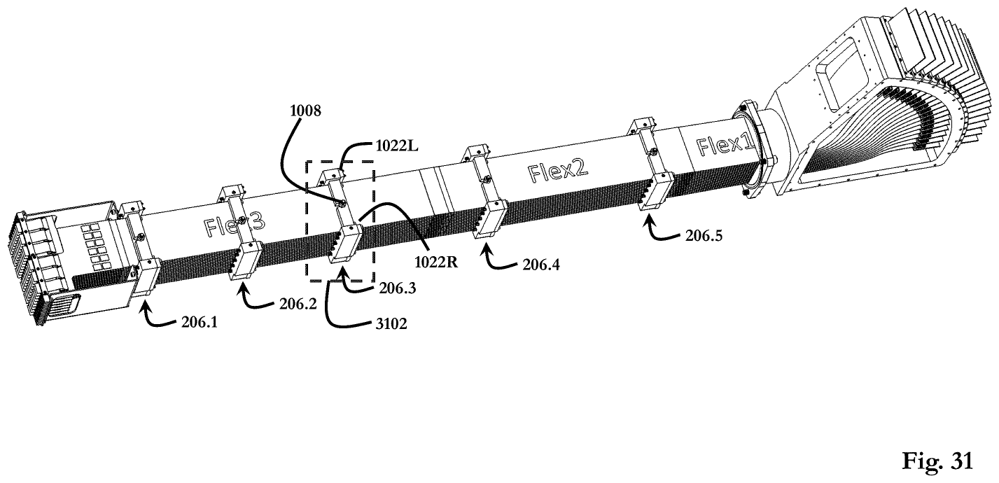

Installations steps recited above for cable 204.1 can then be repeated for each of the remaining cables 204.2, 204.3, . . . , 204.18, in that order. The result after installation of cable 204.2 is illustrated in FIG. 28; the result after installation of cable 204.3 is illustrated in FIG. 29; the result after installation of cable 204.18 is illustrated in FIG. 30. For installation of the last several cables (e.g., 204.16, 204.17, 204.18), front port 1710 of harp 1510 can be useful for accessing screws 2002 illustrated in FIG. 20. As illustrated in FIG. 31, after all cables have been inserted, left thermalization cap 1022L, right thermalization cap 1002R, and nut 1008 can be installed at each of the five instances of thermalization assembly 206.i (i=1, . . . ,5).

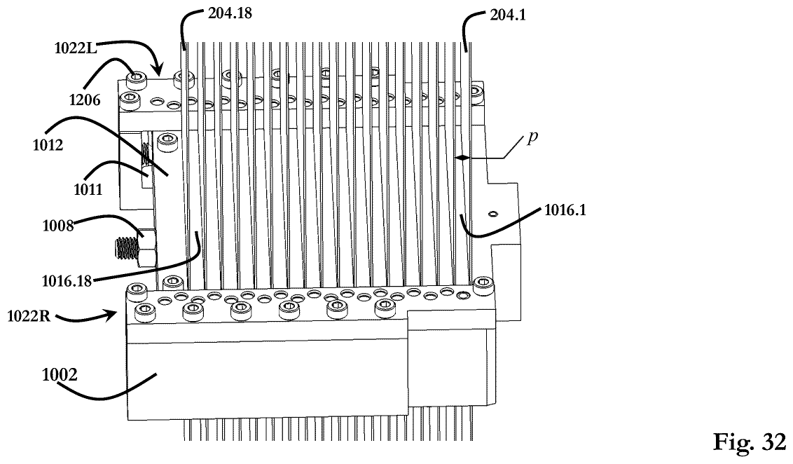

A magnified, side-perspective view of thermalization assembly 206.3, extracted from area 3102 of FIG. 31, is illustrated in FIG. 32. Referring to FIG. 32 as well as FIG. 10 and FIG. 11, nut 1008 can be secured hand tight to ensure abutment of the stack of alternating flex cables 204.i and thermalization bars 1016.i. Next, screws 1206 can be tightened to compress compliant elements 1204 of thermalization caps 1022L and 1022R, thereby ensuring that thermalization bars 1016.i are firmly seated on left-and-right surfaces 1011 of U-channel 1002. Finally, nut 1008 can be tightened firmly to produce a high normal force in the stack of flex cables and thermalization bars, thereby ensuring good thermal contact therebetween. Thus, thermalization bars 1016.i and thermalization caps 1022L and 1022R work together to produce a low-thermal-resistance path between flex cables 204.i and refrigerator flange 104.1—from cables 204 to bars 1016, to U-channel 1002 to flange 104.1, against which U-channel 1002 is abutted by the force of screws 1010.

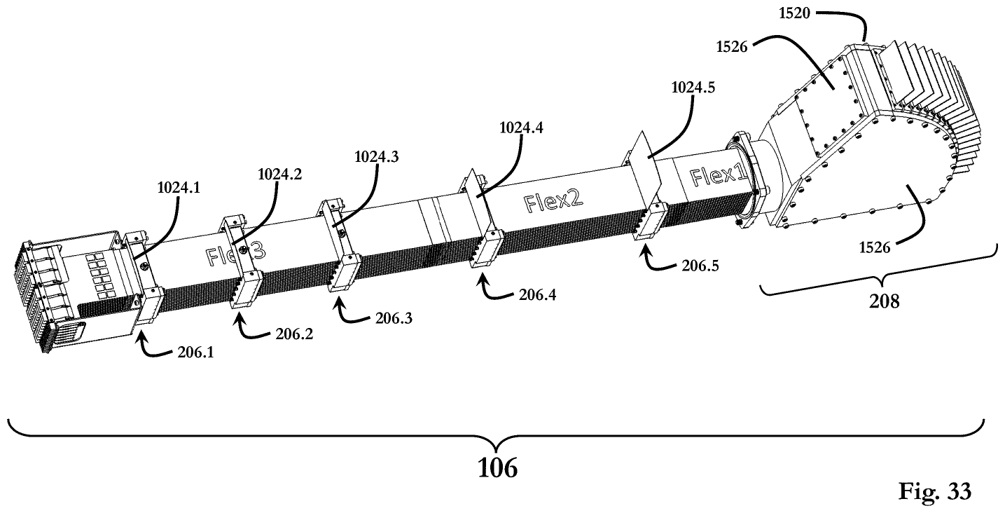

Referring to FIG. 33, the final two assembly steps of signal-delivery system 106 can be, first, addition of left side plate 1520, right side plate 1526, and front plate 1528 to fan-out assembly 208; and second, addition of radiations shields 1024.i to thermalization assemblies 206.i, thereby to close gaps in refrigerator flanges 104.1 through 104.6 shown in FIG. 1, and thereby to prevent high-temperature radiation from penetrating to lower-temperature stages of refrigerator 102.

In various embodiments, the one or more embodiments presented provide various improvements in signal transmission throughout a cryogenic refrigerator. For example, the system described herein increases the number of signals that can be transmitted within a physical space. The use of flex cables, each of which can carry many signals, as opposed to discrete coax cables, each of which only carry one signal at a time, enables more signals to be transmitted. Additionally, in using multiple flex segments per cable, in order to form the long cables utilized, the cable segments within system 106 are overlapped and permanently joined to each other rather than being demountably joined with space-consuming mechanical connectors that would compromise cable-to-cable packing density. Referring to FIG. 32, these two strategies can enable cable-to-cable pitch p on the order of 4.5 mm, which yields signal density approximately an order of magnitude larger than that achievable with discreate coax cables, and approximately a factor of 1.5 larger than that achievable with flex-cables whose segments are joined by mechanical connectors.

In another example, the physical labor involved to assemble system 106 is decreased, for three reasons. Firstly, each flex cable of system 106 carries many signals that can be terminated all at once with relatively little effort by a mass-termination connector, whereas individual coax cables would require laborious termination by individual connectors. Secondly, referring to FIG. 6, the aforesaid permanent joining of flex-cable segments obviates labor-intensive, segment-to-segment connections during deployment. Thirdly, referring to FIG. 15 through FIG. 20, vacuum sealing in system 106 is handled by fan-out assembly 208, in which each cable is separately sealed by an O-ring at the fanned-out end where space for such O-rings is available; consequently, the need for labor-intensive, leak-prone seals (such epoxy seals at refrigerator flange 104.6) is eliminated.

In another example, the reliability of reliability of system 106 is enhanced by the strategies recited above regarding permanent joining of flex-cable segments and O-ring-sealing. In an additional example, the cost of design and manufacturing for system 106 is minimized because all cables have the same length, which is enabled by the permanent joining of flex-cable segments and by the design of fan-out assembly 208. The cost of system 106 is further minimized, and availability of the flex cables therein is enhanced, by ensuring that each flex-cable segment is no longer than what is commonly available in the flex-cable industry (typically □=560 mm), which is enabled by the design of fan-out assembly 208 In a further example, heat-load on the various temperature stages of refrigerator 102 is minimized in system 106 by thermalization assemblies 206, illustrated in FIGS. 10, 11, 12, 13, 14, and 32. Thermalization assembly 206.i at flange i provides sinking of heat conducted from flange i+1 to flange i, lest that heat be conducted to flange i−1, whose lower cooling capacity could be overwhelmed thereby. In an additional example, the cabling in system 106 is relatively insensitive to the details of cryogenic refrigerator 102, in particular to distance between the various thermal flanges 104.1 through 104.6, because thermalization assemblies 206 can intercept the cables at any point except in the small areas where adjacent flex-cable segments are permanently joined. This enables system 106 to be generalized and used across a variety of different cryogenic refrigerators, without the need for extensive modification and/or customization.

Embodiments of the present invention may be a system, a method, and/or an apparatus at any possible technical detail level of integration. What has been described above includes mere examples of systems, methods, and apparatus. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings, such terms are intended to be inclusive in a manner similar to the term “comprising” as “comprising” is interpreted when employed as a transitional word in a claim.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While certain example embodiments have been described, these embodiments have been presented by way of example only, and are not intended to limit the scope the disclosures herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions and changes in the form of the methods and systems described herein may be made without departing from the spirit of the disclosures herein. The accompanying claims and their equivalents are intended to cover such forms or modifications as would fall within the scope and spirit of certain of the disclosures herein.

What is claimed is:

1. A structure comprising:
a plurality of cables between a lower interconnect assembly and a fanout assembly,
wherein the fanout assembly is structured such that one or more cables of the plurality of cables fans out radially from an inlet to an edge of a vacuum tight casing.

2. The structure of claim 1, wherein cables of the plurality of cables comprise substantially similar lengths.

3. The structure of claim 1, wherein one or more cables of the plurality of cables comprises a plurality of spliced cable segments.

4. The structure of claim 1, further comprising one or more thermalization assemblies that thermally anchor the plurality of cables to one or more cryogenic temperature flanges at one or more temperature stages of a cryogenic refrigerator.

5. The structure of claim 4, wherein the fanout assembly is mounted to an outer surface of a room-temperature flange of the cryogenic refrigerator.

6. The structure of claim 5, wherein the fanout assembly extends volume of a vacuum-tight interior of the cryogenic refrigerator.

7. A structure comprising:
a plurality of cables between a lower interconnect assembly and a fanout assembly; and
one or more thermalization assemblies that thermally anchor the plurality of cables to one or more cryogenic temperature flanges at one or more temperature stages of a cryogenic refrigerator.

8. The structure of claim 7, wherein the one or more thermalization assemblies comprise:
a U-channel bracket; and
a plurality of thermalization bars within the U-channel bracket, wherein the plurality of thermalization bars are interleaved with the plurality of cables.

9. The structure of claim 8, wherein one or more cables of the plurality of cables comprises at least one of a stripline or a microstrip.

10. The structure of claim 8, wherein one or more cables of the plurality of cables comprises a plurality of spliced cable segments.

11. The structure of claim 8, wherein the fanout assembly is structured such that one or more cables of the plurality of cables fans out radially from an inlet to an edge of a vacuum tight casing.

12. The structure of claim 8, wherein the fanout assembly is mounted to an outer surface of a room-temperature flange of the cryogenic refrigerator.

13. The structure of claim 12, wherein the fanout assembly extends volume of a vacuum-tight interior of the cryogenic refrigerator.

14. A structure comprising:
a plurality of cables between a lower interconnect assembly and a vacuum-tight fanout assembly, wherein the vacuum-tight fanout assembly comprises a plurality of feedthrough circuit assemblies.

15. The structure of claim 14, wherein one or more feedthrough circuit assemblies of the plurality of feedthrough circuit assemblies comprises an interior portion located within a vacuum space and an exterior portion located outside the vacuum space.

16. The structure of claim 15, wherein one or more feedthrough circuit assemblies of the plurality of feedthrough circuit assemblies further comprises a vacuum seal mounted to an external surface of the vacuum-tight fanout assembly.

17. The structure of claim 15, wherein the vacuum-tight fanout assembly is mounted to an outer surface of a room-temperature flange of a cryogenic refrigerator.

18. The structure of claim 17, wherein the vacuum-tight fanout assembly extends volume of a vacuum tight interior of the cryogenic refrigerator.

19. The structure of claim 15, wherein the vacuum-tight fanout assembly is structured such that one or more cables of the plurality of cables fans out radially from an inlet to an edge of a vacuum tight casing.

20. The structure of claim 15, wherein one or more cables of the plurality of cables comprises a plurality of spliced cables.
